(19) United States
(12) Patent Application Publication
(10) Pub. No.: US 2012/0148206 A1
(43) Pub. Date: Jun. 14, 2012

(54) Rare-Earth-Doped Optical Fiber

(75) Inventors: David Boivin, Longjumeau (FR); Alain Pastouret, Massy (FR); Ekaterina Burov, Boulogne-Billancourt (FR); Cedric Gonnet, Paris (FR)

(73) Assignee: DRAKA COMTEQ, B.V., Amsterdam (NL)

(21) Appl. No.: 13/315,712

(22) Filed: Dec. 9, 2011

(30) Foreign Application Priority Data
Dec. 10, 2010 (FR) 10/60398

(51) Int. Cl. G02B 6/02; B82Y 99/00

(52) U.S. Cl. 385/123; 977/773; 977/932

(57) ABSTRACT

An optical fiber includes a central core and an optical cladding. The central core includes a core matrix surrounding nanoparticles. The nanoparticles include rare earths, a nanoparticle matrix, and an outer layer. The nanoparticle matrix surrounds the rare earths, and the outer layer surrounds the nanoparticle matrix. The atomic ratio of nanoparticle matrix atoms other than oxygen to rare earth atoms is typically between about 300 and 1,000. The outer layer, which typically has a thickness of between about 1 nanometer and 2 nanometers, includes an outer layer matrix that is substantially free from rare earths.

### CROSS-REFERENCE TO PRIORITY APPLICATION

This application hereby claims the benefit of pending French application Ser. No. 10/60398 for a “Fibre Optique Dopee en Terres Rares Presentant De Faibles Interactions Entre Les Elements Dopants” (filed Dec. 10, 2010 at the National Institute of Industrial Property (France)), which is hereby incorporated by reference in its entirety.

### FIELD OF THE INVENTION

The present invention relates to the field of optical fibers and, more specifically, to an optical fiber doped with elements from the rare-earth group (referred to below as “rare earths”).

### BACKGROUND

An optical fiber (i.e., a glass fiber typically surrounded by one or more coating layers) conventionally includes an optical fiber core, which transmits and/or amplifies an optical signal, and an optical cladding, which confines the optical signal within the core (i.e., the central core). Accordingly, the refractive index of the core n_{c} is typically greater than the refractive index of the optical cladding n_{g} (i.e., n_{c}>n_{g}). The refractive index difference between the central core and the cladding is typically obtained by introducing dopants into the central core and/or the cladding.

Typically, the core and the optical cladding are obtained by vapor deposition, such as inside chemical vapor deposition (CVD) (e.g., modified chemical vapor deposition (MCVD)), outside vapor deposition (OVD), or vapor axial deposition (VAD), etc. With a inside CVD-type method, the outer cladding is constituted by the deposition tube and possibly also by overcladding or by sleeving. The central core is formed of a matrix optionally including doping elements. The core matrix is generally made of silica. In general, elements that are not very volatile (e.g., rare earths, aluminum, etc.) are incorporated by impregnating a porous silica bar during a CVD operation for forming the core of the primary preform. With rare earths, impregnation may be performed, for example, using a solution having rare earths obtained from dissolved salts. Once inserted in the core, the rare earths are present in their ionic form.

Optical fibers doped with rare earths are commonly used in numerous optical applications. In particular, optical fibers doped with rare earths may be used as line amplifiers for broadband transmission.

Erbium-doped optical fibers may be used in long distance optical telecommunications systems to amplify optical signals. Such optical fibers are used in erbium-doped fiber amplifiers (EDFAs) and have a core that includes a silica matrix containing rare earths, such as erbium at concentrations on the order of 250 parts per million (ppm) to 1,000 ppm (i.e., 0.025 weight percent to 0.1 weight percent (wt %)).

Optical amplification in a rare-earth-doped fiber operates by injecting a so-called “pump” signal into the optical fiber. The pump signal excites the rare earth ions. When an incident signal passes through this portion of optical fiber, the rare earth ions de-excite and, by simulated emission, produce photons that are substantially identical to those from the incident signal. The incident signal is thus amplified.

The gain “shape” of an amplifying optical fiber designates the value of its gain as a function of the wavelength of the incident signal. The gain “width” designates the range of wavelengths over which the gain remains greater than a predetermined value. For example, an erbium-doped optical fiber is advantageously used in band C (1530 nanometers to 1565 nanometers). An erbium-doped fiber conventionally presents a gain width of about 30 nanometers to 35 nanometers in the C-band.

Optical fibers that are strongly doped with rare earth ions are attracting more and more interest. Firstly, increasing the quantity of rare earth ions in an optical fiber makes it possible to increase its gain per unit length and thus to reduce the length of optical fiber that is needed for achieving a given amplification. Thus, the cost and the size of the system including the amplifying optical fiber are reduced. Furthermore, a strongly doped optical fiber is particularly suitable for amplification in band L (1565 nanometers to 1625 nanometers).

Nevertheless, when the concentration of rare earths in the matrix of the optical-fiber core becomes high, the mean distance between two adjacent rare earths decreases. This gives rise to the formation of rare-earth pairs or, indeed, of rare-earth aggregates in the core matrix, thereby creating doping non-uniformities. This reduction in the mean distance between rare earths increases the probability of neighboring rare earths interacting with one another. The energy delivered to the optical fiber by the pump signal suffers losses as a result of these energy transfers between neighboring rare earths. The simultaneous existence of mechanisms other than those that give rise to amplification thus degrades the amplification efficiency of the optical fiber.

Two main interaction mechanisms between neighboring rare earths are homogeneous upconversion (HUC) and pair-induced quenching (PIQ). The effects of these mechanisms depend strongly on the distance between the rare earths.

Homogeneous upconversion takes place between rare earths that are distributed uniformly, with the distance between them being on the order of a nanometer. This mechanism can be better understood by making reference to FIG. 1, which is an energy diagram for two neighboring rare earths. Because of their proximity, an acceptor rare earth 1 receives energy W_{HUC} from a donor rare earth 2. The rare earth 2 is subjected to relaxation 9 towards a fundamental energy state ⁴I_{15/2}. It can then contribute to amplifying the incident signal only if it is once more excited by a pump photon. The energy transfer W_{HUC} serves to excite the rare earth 1 from a metastable energy level ⁴I_{13/2} to an energy level ⁴I_{9/2} (excitation 10). Thereafter, the rare earth 1 relaxes towards energy state ⁴I_{13/2}.

This relaxation may include passing via energy state ⁴I_{11/2}. Under such circumstances, the rare earth 1 is subjected to relaxation 12 from the state ⁴I_{9/2} to state ⁴I_{11/2}, and then to relaxation 14 from state ⁴I_{11/2} to state ⁴I_{13/2}. The relaxations 12 and 14 do not radiate (i.e., no photon is emitted at the wavelength that corresponds to the energy difference between the energy levels). In contrast, the energy difference is dissipated in the form of heat (thermal effect) or in the form of a vibration wave or phonon (i.e., a wave that is acoustic and not optical).

In the presence of an incident signal photon, the rare earth 1 is subjected to relaxation 16 from state ⁴I_{13/2} to energy state ⁴I_{15/2}, thus producing a photon identical to the incident signal photon. This simulated emission enables the incident signal to be amplified. However, the energy balance of the system constituted by the two rare earths shows that two pump photons have produced one incident signal photon. If the HUC mechanism does not occur, then two pump photons would have given rise to two incident signal photons. Homogeneous upconversion thus degrades the efficiency of the optical amplification mechanism.

The relaxation 18 is very unlikely. If it does occur, however, then two pump photons are consumed but no photon is obtained for amplifying the incident signal. In the presence of an incident signal photon, the relaxation 18 forms a photon at the wavelengths of the incident signal but having properties that are different from those of the incident signal photon. The photon is emitted in a random direction and with a random phase. The photon emitted by the relaxation 18 therefore cannot be used for amplifying the incident signal.

Pair-induced quenching is known, for example, from the publication by Delevaque et al. entitled “Modeling of pair-induced quenching in erbium-doped silicate fibers,” IEEE Photonics Technology Letters, Vol. 5, No. 1, pp. 73-75 (1993), which is hereby incorporated by reference in its entirety. The PIQ mechanism appears when two rare earths are very close together. This happens when the rare earths are separated by a distance on the same order as their diameter (e.g., 0.2 nanometer). The two rare earths are then coupled together so strongly that they form a pair. They cannot be excited together to energy state ⁴I_{13/2} in stable manner. This can be better understood by referring to FIG. 2, which is an energy diagram for a pair including two rare earths.

In a phase I, the rare earth 1 is in energy state ⁴I_{15/2} and the rare earth 2 is in energy state ⁴I_{13/2}. On absorbing a pump photon, the rare earth 1 is subjected to an excitation 20 to state ⁴I_{13/2}. Immediately after the pump signal has passed, the pair is in a phase II: both rare earths are in state ⁴I_{13/2}. This phase is of very short duration compared with the time scales of the PIQ mechanism. The rare earth 1 is subjected to a relaxation 22 to state ⁴I_{15/2}, thus transferring energy to the rare earth 2. By means of this energy, the rare earth 2 is subjected to an excitation 24 towards state ⁴I_{9/2}. The pair is then in a phase III. The pair remains in phase III for about 50 nanoseconds (ns). However, the rare earth 2 does not remain in state ⁴I_{9/2}, and it is subjected to non-radiating relaxations 26 and 28 that return it to state ⁴I_{13/2}. Thus, at the end of the PIQ mechanism, only the rare earth 2 is available for amplifying the incident signal. A pump photon has been absorbed without being made available for amplifying the incident signal. Without the PIQ mechanism, the rare earths 1 and 2 would both be available for amplification.

The performance of the rare-earth-doped optical fiber is thus highly dependent on the distances between the rare earths.

One solution includes reducing the quantity of rare earths and increasing the length of the optical fiber to achieve a given amplification gain. By reducing the quantity of rare earths, the mean distance between the adjacent rare earths increases. Thus, the probability of the PIQ and HUC mechanisms decreases. For example, an amplifier having a gain of 80 decibels (dB) may be made with 2 meters (m) of rare-earth-doped optical fiber presenting a gain of 40 decibels per meter (dB/m), or with 8 meters of a rare-earth-doped optical fiber presenting a gain of 10 dB/m. Nevertheless, increasing the length of the amplifying optical fiber increases the size of the amplifier.

Another solution includes inserting codopants, or complementary dopants, together with the rare earths. These codopants serve to improve amplification by preventing interactions between the rare earths. For example, alumina is known to improve the gain flatness that is needed in broadband amplification and to reduce the aggregation of rare earths (e.g., erbium). To be effective, the codopants need to surround the rare earth ions. While the optical fiber is being doped by a solution containing rare earths, the concentration of codopants is very high to ensure that each rare earth ion in the core is surrounded by codopants. However, the quantity of codopants that can be inserted into the core is limited, because such codopants can modify the refractive index of the core and increase background losses and/or modify gain shape.

Also known are core matrices that enable energy transfers between rare earth ions to be reduced. Such core matrices are therefore capable of receiving large quantities of rare earth ions. For example, phosphate glass and fluoride glass are known (i.e., glass containing phosphorous or fluorine). A glass ceramic or ZBLA (ZrF₄—BaF₂—LaF₃—AlF₃) matrix is also known. These matrices may present drawbacks. For example, fluoride or phosphate glasses are very sensitive to hydroxide ions and poor at withstanding moisture. Furthermore, optical fibers including such matrices are difficult to make compatible with standard optical fibers in which the core matrices are generally made of silica. For example, it is difficult to weld a splice between an optical fiber that includes such a matrix and a standard optical fiber.

The publication by Tammela et al. entitled “Potential of Nanoparticle Technologies for Next Generation Erbium-Doped Fibers,” OFC2004 Technical Digest, FB5 (2004), which is hereby incorporated by reference in its entirety, describes an optical fiber fabrication method including direct nanoparticle deposition (DND). The authors make use of outside vapor deposition in which the glass having dopant precursors is heated by the flame of a specially-designed torch. The glass and the precursors react to form rare-earth soots. The DND technique enables the rare earths to be dispersed uniformly even at high concentrations. The chemical environment of the rare earths (i.e., the atoms immediately neighboring each rare earth) mainly determines the fluorescence properties of the rare earths that contribute to the main gain characteristics. The rare earths are inserted in the core matrix. The environment of a rare earth thus depends on the composition of the core matrix. The DND technique is a random method that does not enable the chemical environment around rare earths to be controlled. Thus, the DND technique does not make it possible to improve the amplification efficiency of the optical fiber for given gain.

It is known to perform rare-earth doping by means of nanoparticles using a modified chemical vapor deposition (MCVD) process. Because the nanoparticle matrix surrounds the rare earth ion, there is better control over the environment of each rare earth ion. For example, European Patent Application Publication No. EP-A-2 194 408, which is hereby incorporated by reference in its entirety, describes optical fibers having nanoparticles in the core of the optical fiber. The nanoparticles include rare earth ions.

European Patent Application Publication No. EP-A-2 194 620, which is hereby incorporated by reference in its entirety, describes an optical fiber in which it is possible to concentrate the rare earth ions in the nanoparticles by avoiding photo-blackening, a parasitic mechanism due to defects present in the silica. Nevertheless, that document does not describe how to eliminate the PIQ and HUC mechanisms.

European Patent Application Publication No. EP-A-2 187 486, which is hereby incorporated by reference in its entirety, describes an optical fiber having rare-earth-doped nanoparticles in which the distance between the rare earth ions is greater than 0.8 nanometer so as to avoid the PIQ mechanism. However, the optical fiber does not take into account the HUC mechanism.

European Patent Application Publication No. EP-A-2 091 115, which is hereby incorporated by reference in its entirety, also describes an optical fiber including nanoparticles. Each nanoparticle presents a matrix of aluminum containing rare earth ions. The nanoparticles also include a non-doped, outside metal layer (e.g., having a thickness of 9 micrometers (μm)). The metallic outer layer of each nanoparticle contributes to improving amplification by a surface plasmon resonance (SPR) phenomenon. Nevertheless, that publication does not describe how to eliminate the PIQ and HUC mechanisms.

Thus, there is a need for a rare-earth-doped optical fiber in which the PIQ and HUC mechanisms are attenuated.

### SUMMARY

In one aspect, the present invention embraces an optical fiber that includes a central core adapted to transmitting an optical signal and an optical cladding surrounding the central core adapted to confine the optical signal transmitted in the central core. The central core is formed of a core matrix surrounding nanoparticles (e.g., the nanoparticles are dispersed within the core matrix). The nanoparticles are formed of a nanoparticle matrix surrounded by an outer layer. The nanoparticle matrix surrounds doping atoms from the group of rare earths (also referred to as “rare earths,” “rare earth dopants,” “rare earth ions,” or “rare-earth-dopant elements”) at a concentration such that the atomic ratio between the number of nanoparticle matrix atoms excluding oxygen and the number of atoms of rare earths is between about 300 and 1,000. The outer layer of the nanoparticles may be formed of an outer layer matrix that is substantially free from atoms of rare earths and that has a thickness of between about 1 nanometer and 2 nanometers.

In an exemplary embodiment, the core matrix is made of silica.

In another exemplary embodiment, the nanoparticle matrix includes alumina (Al₂O₃) and/or silica (SiO₂).

In yet another exemplary embodiment, the outer layer of the nanoparticles is made of alumina (Al₂O₃), silica (SiO₂), or a combination thereof.

In yet another exemplary embodiment, the doping elements of the group of rare earths (130) are selected erbium (Er), ytterbium (Yb), or thulium (Tm), or a combination of these rare earths.

In yet another exemplary embodiment, the nanoparticles have an atomic ratio between the number of nanoparticle matrix atoms other than oxygen and the number of atoms of rare earths that is between about 350 and 550.

In yet another exemplary embodiment, the percentage by weight of the nanoparticle matrix in the central core is between about 0.5 weight percent and 3.5 weight percent.

In yet another exemplary embodiment, the nanoparticles are substantially spherical with a diameter of between about 5 nanometers and 50 nanometers.

In yet another exemplary embodiment, the concentration of rare-earth doping elements in the central core is at least about 250 ppm, such as between about 250 ppm and 1,500 ppm.

In yet another exemplary embodiment, the core matrix further includes an additional dopant that contributes to the refractive index difference between the central core and the optical cladding (e.g., provides an increased or decreased refractive index difference). The additional dopant may include, for example, germanium, fluorine, aluminum, or phosphorous, or a combination thereof.

In another aspect, the present invention embraces an optical-fiber laser that includes a portion of the present optical fiber. The invention also embraces an optical amplifier that includes a portion of the present optical fiber and that uses a pump power of between about 60 milliwatts (mW) and 1.5 watts (W).

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 (described above) depicts an energy diagram relating to two rare earths when an HUC mechanism occurs.

FIG. 2 (described above) depicts an energy diagram relating to two rare earths when a PIQ mechanism occurs.

FIG. 3 schematically depicts a cross-sectional view of an exemplary optical fiber according to the present invention.

### DETAILED DESCRIPTION

In one aspect, the present invention seeks to reduce the above-described PIC and HUC mechanisms. There exists a minimum distance between rare earths below which energy transfers occur between adjacent rare earths. In an exemplary optical fiber according to the present invention, the nanoparticles include an outer layer and a controlled atomic ratio between the number of atoms in the nanoparticle matrix other than oxygen and the number of atoms of rare earths. This atomic ratio makes it possible to control the environment of the rare earths so as to obtain a mean distance between rare earths that is greater than aforementioned minimum distance. Thus, in an exemplary optical fiber according to the present invention, parasitic energy transfers between rare earths are attenuated or even eliminated.

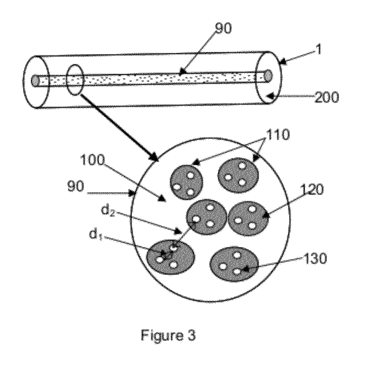

An exemplary optical fiber according to the present invention is described below with reference to FIG. 3, which depicts an exemplary optical fiber 1 with an enlargement of its central core 90. The optical fiber 1 has a central core 90 suitable for transmitting an optical signal and optical cladding 200 surrounding the central core 90 that is suitable for confining the optical signal that is being transmitted in the central core 90.

The central core 90 includes a core matrix 100 and nanoparticles 110, which are typically randomly dispersed within the core matrix 100. The core matrix 100 surrounds the nanoparticles 110. For example, the core matrix 100 is based on silica.

In an exemplary embodiment, the core matrix 100 also includes an additional dopant (not shown) that contributes to the index difference between the central core 90 and the optical cladding 200 (e.g., increases or decreases the central core's refractive index). For example, the additional dopant may be germanium, fluorine, aluminum, phosphorous, or a combination of these elements. For example, the concentration in additional dopants is between about 1 weight percent and 10 weight percent.

In a particular example, the core matrix 100 is made of silica and the additional dopant is germanium.

The central core 90 presents a refractive index difference relative to the optical cladding that makes it possible to obtain optical-signal guidance properties. For example, the refractive index difference relative to the optical cladding may be between about 10×10⁻³ and 30×10⁻³.

The core matrix 100 surrounds the nanoparticles 110 (e.g., the nanoparticles are dispersed within the core matrix). The nanoparticles 110 are doped with rare earths 130. Each nanoparticle 110 is made of a nanoparticle matrix 120 that surrounds rare earths 130 (e.g., the rare earths 130 are dispersed within the nanoparticle matrix 120). Doping with nanoparticles 110 thus makes it possible to obtain a better dispersion of the rare earths 130 than doping in a way that makes use of impregnation via dissolved salts.

The composition and the structure of the nanoparticle matrix 120 encourage the dissolution of rare earths 130. This nanoparticle matrix 120 may be distinct from the core matrix 100 of the central core 90. The rare earths are in ionic form with charge that is balanced by the oxygen ions present in the nanoparticle matrix 120. The nanoparticle matrix 120 comprises one or more chemical elements in oxidized form. The matrix 120 of the nanoparticles 110 comprises one or more oxides that enable the rare earths 130, which provide the gain properties of the optical fiber 1, to be dissolved uniformly while maintaining a physical barrier between the rare earths 130 and the crystal defects of the core matrix 100 of the central core 90. The nanoparticle matrix 120 typically does not contribute defects that are troublesome for emission efficiency as a function of utilization time. In addition, the nanoparticle matrix 120 withstands the conditions of fabricating the optical fiber 1. The nanoparticle matrix 120 may include, for example, silica (SiO₂) and/or alumina (Al₂O₃). Alumina provides a good distribution of rare earths 130 within a nanoparticle 110 and makes it possible to widen the amplification gain in the spectrum window for wavelength division multiplexing (WDM) applications.

The nanoparticles 110 present an atomic ratio between the number of nanoparticle matrix atoms other than oxygen and the number of atoms of rare earths 130 of between about 300 and 1,000 (e.g., less than 750, such as between about 350 and 550). The atomic ratio designates the ratio of the quantity of matrix atoms other than oxygen to the quantity of rare earth atoms present in the nanoparticles. This range of values makes it possible to obtain an average distance d₁ between the rare earths 130 contained within a given nanoparticle 110 that is greater than or equal to 2 nanometers. Firstly, the PIQ mechanism takes place when rare earths 130 are spaced apart by a distance of between about 0.2 nanometer and 0.4 nanometer. Secondly, the HUC mechanism takes place when the rare earths 130 are spaced apart by a distance of less than 2 nanometer. Thus, in the optical fiber 1 according to the present invention, the average distance d₁ between rare earths 130 in a nanoparticle 110 is sufficiently great to reduce or even eliminate the HUC and PIQ mechanisms between the rare earths 130 of a nanoparticle 110.

In general, the phrase “average distance d₁” refers to the average separation between each doping ion and its nearest adjacent doping ion (i.e., the average of the distances of each set of two doping ions). In this regard and as depicted in FIG. 3, the phrase “average distance d₁” is a useful way to characterize the separation between sets of neighboring doping ions within the nanoparticle's matrix material.

The nanoparticles 110 also have an outer layer (not shown) that is substantially free from rare earths 130 (e.g., a nanoparticle's peripheral portion might not include any rare earths). The outer layer presents a thickness of between about 1 nanometer and 2 nanometers.

Thus, two rare earths 130 contained in two different nanoparticles 110 are spaced apart by a distance d₂ that is greater than or equal to 2 nanometers, even if the nanoparticles are touching. Thus, in the exemplary optical fiber 1, the distance d₂ between the rare earths 130 of two different nanoparticles 110 is sufficiently great to eliminate the HUC and PIQ mechanisms between those rare earths 130. In other words, the outer layer serves to reduce or even eliminate the HUC and PIQ mechanisms between the rare earths 130 in two different nanoparticles.

In this regard and as depicted in FIG. 3, the phrase “distance d₂” is a useful way to characterize the separation between neighboring rare earths in different nanoparticles within the central core's matrix material.

Most or even all of the nanoparticles 110 present the above-described characteristics, i.e., (i) the value of the atomic ratio between the number of nanoparticle matrix atoms other than oxygen and the number of atoms of rare earths 130 and (ii) the thickness of the outer layer that is substantially free of rare earths 130.

In general, at least 80 percent (e.g., at least 85 percent) of the nanoparticles 110—and typically 90 percent (e.g., at least 95 percent) of the nanoparticles 110—exhibit the nominal nanoparticle characteristics (e.g., shapes, dimensions, constituent concentrations, and separation distances).

The characteristics of the nanoparticles 110 may be determined by techniques and apparatuses that make use of light refraction or diffusion. These characteristics may also be confirmed by electron microscope observations. In particular, the thickness of the outer layer may be determined by electron microscopy.

Below, the PIQ mechanism is characterized by the percentage of the rare earths 130 of the optical fiber that are involved in a PIQ mechanism. In other words, the PIQ mechanism is characterized by the percentage of rare earths 130 that are involved in a pair.

In addition, the HUC mechanism is characterized below by the energy transfer rate W_{HUC} expressed in cubic meters per second (m³·s⁻¹).

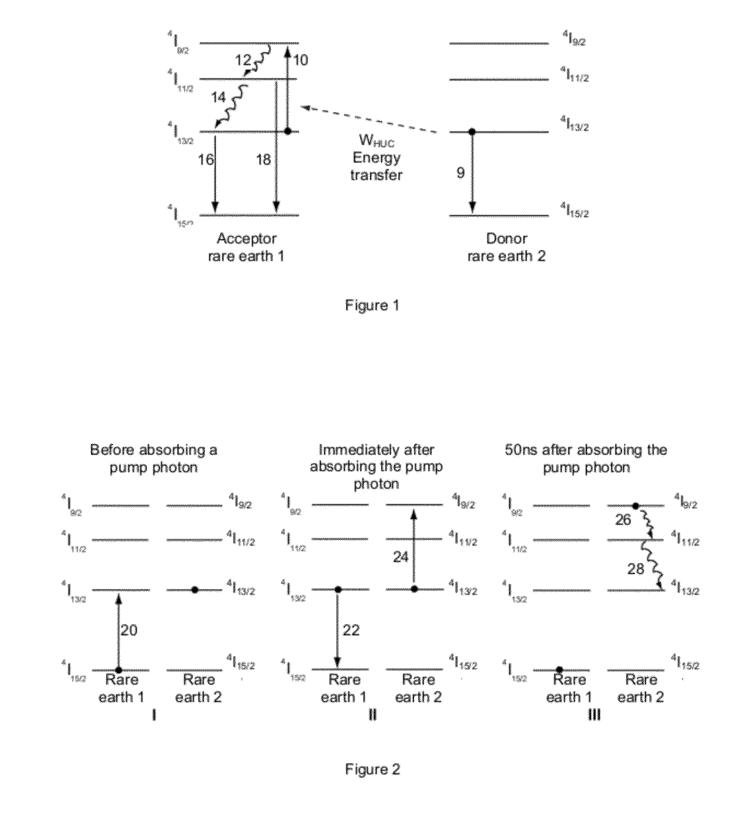

The rare earth percentage and the energy transfer rate W_{HUC} are obtained from a known model, such as the model described in the publication by Marcerou et al. entitled “General Theoretical Approach Describing the Complete Behavior of the Erbium-Doped Fiber Amplifier” published in Proceedings of SPIE, Vol. 1373, pp. 168-186 (1990), which is hereby incorporated by reference in its entirety. The values for rare earth percentage and for transfer rate as presented below were obtained from the model of the Marcerou publication, taking account of the HUC mechanism as shown in FIG. 1 and of the PIQ mechanism as shown in FIG. 2. Those having ordinary skill in the art will recognize that other models for determining the percentage of pairs and the energy transfer rate W_{HUC} may be used.

Typically, the percentage of pairs involved in a PIQ mechanism increases with the concentration of rare earths 130 in the central core 90. In exemplary optical fibers according to the present invention, the percentage of pairs increases more slowly with increasing concentration of rare earths 130 than in a conventional optical fiber doped with a solution of rare earths. In an optical fiber doped with a solution of rare earths, the percentage of pairs increases with rare earth concentration at a slope of 2.31×10⁻²⁵ percent cubic meters (%·m³).

In contrast, an exemplary optical fiber according to the present invention has a pair percentage that increases with the concentration of rare earths 130 at a slope of less than 1.45×10⁻²⁵%·m³. This reduced pair-percentage-increase slope may be attributed to two factors: (i) the atomic ratio between the number of nanoparticle matrix atoms other than oxygen and the number of atoms of rare earths 130; and (ii) the outer layer of the nanoparticles 110.

Typically, the energy transfer rate W_{HUC} associated with the HUC mechanism increases with increasing rare earth concentration. An exemplary optical fiber according to the present invention typically has an energy transfer rate W_{HUC} that remains substantially constant with increasing concentration of rare earths 130 for at least two reasons: (i) the atomic ratio between the number of nanoparticle matrix atoms other than oxygen and the number of atoms of rare earths 130; and (ii) the outer layer of the nanoparticles. In other words, the energy transfer rate W_{HUC} does not vary significantly with rare earth concentration. For example, the energy transfer rate W_{HUC} remains constant to within plus or minus 0.1×10⁻²⁴ m³·s⁻¹. The value of the energy transfer rate W_{HUC} depends on the value of the atomic ratio between the number of nanoparticle matrix atoms other than oxygen and the number of atoms of rare earths 130.

When an exemplary optical fiber is used for amplifying an optical signal, the lower attenuation of the PIQ and HUC mechanisms enables pump signal power losses to be reduced. Thus, the pump power required to obtain a given gain is decreased. This achieves an energy savings, reduces operating costs, and provides greater reliability for the system including the optical fiber.

By way of example, the nanoparticle's outer layer is made of silica or of alumina or a combination of both. In one embodiment, the outer layer and the matrix 120 of the nanoparticles 110 have the same composition.

The concentration of rare earths 130 serves to obtain a given amplification gain. In the optical fiber 1 according to the present invention, the PIQ and HUC mechanisms are attenuated or even eliminated. Thus, in the optical fiber 1 the concentration of rare earths 130 is not limited by the interaction mechanisms between two neighboring rare earths.

Thus, in an exemplary embodiment, the optical fiber according to the present invention has a strongly doped core 90 while also having PIQ and HUC mechanisms that are attenuated by the atomic ratio between the number of nanoparticle matrix atoms other than oxygen and the number of atoms of rare earths 130 and because of the outer layer of each nanoparticle 110. In this exemplary embodiment, the concentration of rare earths 130 in the central core 90 is between about 250 ppm and 1,500 ppm (e.g., between about 500 ppm and 1,000 ppm). In a particular example, the central core 90 has a concentration of rare earths 130 of 1,400 ppm, a percentage of pairs of less than 4 percent, and an energy transfer rate W_{HUC} of less than 0.5×10⁻²⁴ m³·s⁻¹.

In the central core 90 of the optical fiber 1, the nanoparticle matrix 120 of the nanoparticles 110 has a concentration of between about 0.5 and 5 weight percent (e.g., between about 1.5 weight percent and 4 weight percent).

The nanoparticles 110 typically have dimensions that facilitate their incorporation into the central core 90. For example, the nanoparticles 110 are substantially spherical in shape with a diameter of between about 5 nanometers and 50 nanometers. In this example, most or even all of the nanoparticles 110 have a shape that is substantially spherical with a diameter of between about 5 nanometers and 50 nanometers.

As noted and in general, at least 80 percent (e.g., at least 85 percent) of the nanoparticles 110—and typically 90 percent (e.g., at least 95 percent) of the nanoparticles 110—exhibit the nominal nanoparticle characteristics (e.g., shapes, dimensions, constituent concentrations, and separation distances).

The rare earths 130 used in the context of the present invention are, for example, erbium (Er), ytterbium (Yb), thulium (Tm), or a combination thereof, or indeed any other rare earth enabling amplification by optical pumping.

When the optical fiber 1 is used to amplify a signal, the gain of the amplifier depends on the rare earths used and on their concentrations. In addition, the optical fiber 1 according to the present invention may be used for other applications, such as a laser.

An example of an optical fiber 1 according to the present invention suitable for amplifying an optical signal is described below. The exemplary optical fiber 1 presents a core 90 with erbium at a concentration of 600 ppm by weight. The nanoparticle matrix 120 is made of alumina and presents a concentration in the central core 90 of 3.5 percent by weight. The alumina contributes to the amplification gain shape. The nanoparticles 110 present a mean diameter of 25 nanometers. In this exemplary optical fiber 1, the nanoparticles 110 have an atomic ratio of aluminum to erbium of 400 and an outer layer of pure alumina with a thickness of 1 nanometer, thus ensuring a distance between two erbium atoms that is greater than 2 nanometers. Thus, the exemplary optical fiber 1 presents a pair percentage of less than 3 percent and an energy transfer rate W_{HUC} of less than 0.5×10⁻²⁴ m³·s⁻¹.

The exemplary optical fiber 1 described above is fabricated using an MCVD technique. The method of fabricating this exemplary optical fiber according to the present invention is described below.

The method includes a step of depositing successive silica-based sintered layers at a temperature of 2,000° C. onto the inside surface of a silica tube. These sintered layers form the optical cladding of the optical fiber 1 obtained after drawing.

The method then includes depositing a porous silica-based layer on the previously deposited inside surface. The porous layer forms a core 90 of the optical fiber 1 after drawing. The porous layer is deposited at a lower temperature (e.g., about 1,400° C.) to avoid vitrifying the layer.

The porous layer is then impregnated with a suspension of nanoparticles 110 in a conventional solvent that may advantageously be water or ethanol. Impregnation is performed at ambient temperature, typically by a liquid doping technique that is fully compatible with MCVD technology.

The concentration by weight of rare earths 130 in the central core 90 of the optical fiber 1 as obtained after drawing is adjusted by varying the concentration of the rare earths 130 in the aqueous solution. In this example, the suspension presents an erbium concentration of 1.75×10⁻³ moles per liter (mol/L), thus making it possible to obtain an erbium concentration of 600 ppm by weight in the central core 90 after the optical fiber 1 has been drawn.

The impregnated, porous layer is subsequently sintered at a temperature of 2,000° C.

The deposition tube containing the successive deposits is then collapsed in order to obtain a primary preform.

Thereafter, the primary preform is sleeved with silica tubes to adjust the diameter of the core and the ratio between the central core 90 and the cladding 200 to predetermined values. This produces a secondary preform.

The exemplary optical fiber according to the present invention is subsequently obtained by drawing the secondary preform.

The nanoparticles 110 are synthesized by a gentle chemical technique that encourages the formation of thermodynamically stable stoichiometric structures and facilitates control over the size and the composition of the nanoparticles 110. A standard method may be used for chemically synthesizing the nanoparticles 110 in an aqueous solution at controlled pH by co-precipitating precursors of alumina salts and rare earth salts. The atomic ratio between the number of nanoparticle matrix atoms other than oxygen and the number of atoms of rare earths 130 in the nanoparticle is defined at this stage by adjusting the weights of the various precursor reactions on the basis of their molecular weight and of the intended atomic ratio. For example, it is possible to use inorganic salts (e.g., nitrates or chlorides) as precursors of alumina, and organic salts (e.g., acetyl acetonate or acetate) as precursors of erbium, ytterbium, or thulium.

The nanoparticles 110 are subsequently coated with an outer layer to a thickness of about 1 nanometer by using chemical or physical synthesis.

After the outer layer has been deposited, the nanoparticles 110 are washed by centrifuging and dispersed in a conventional solvent, such as water or ethanol.

To ensure that the matrix 120 of the nanoparticles is conserved in the final optical fiber and remains capable of constituting a physical barrier between the rare earths 130 and crystal defects of the matrix 100 of the central core 90, it is important for the nanoparticle matrix 120 to be capable of withstanding the conditions (temperature and stress) of fabricating the optical fiber. Thus, for certain nanoparticle matrices 120, it is possible to provide a step of thermally densifying the nanoparticles 110 after they have been incorporated in the porous layer of the primary preform by impregnation and before the layer that has been doped in this way is sintered (or vitrified). The tube may thus be subjected to heat treatment at a temperature greater than 1,000° C. for at least one hour in order to reinforce the structure of the nanoparticles 110 in the central core 90.

In another aspect, the present invention embraces an optical amplifier having at least a portion of the optical fiber according to the present invention and using a pump power of between about 60 mW and 1,500 mW. Compared with a conventional amplifier, the length of optical fiber used is shortened, because the optical fiber according to the present invention can accommodate rare earths at a very high concentration. Thus, the dimensions of the amplifier are reduced compared with a conventional amplifier. Furthermore, the attenuation due to the HUC and PIQ mechanisms serves to reduce losses of the pump signal. Optical pumping is thus more efficient.

In yet another aspect, the present invention embraces an optical fiber laser having at least a portion of the optical fiber according to the present invention.

Typically, an optical fiber laser includes a portion of optical fiber in combination with a resonant cavity constituted by a system of mirrors or of Bragg gratings. The wavelength and the power of the optical fiber laser depend on the rare earths used and on their concentration in the optical fiber.

Compared with a conventional optical fiber laser, the length of optical fiber used may be shorter, because the optical fiber according to the present invention accommodates rare earths at a high concentration. The optical fiber according to the present invention serves to reduce the non-linear effects of the laser that depend on the length of optical fiber used.

The above-described exemplary optical fiber according to the present invention is not limiting on the possible applications of the invention. In particular, the optical fiber according to the present invention may be made using nanoparticles 110 having a matrix 120 other than an alumina matrix and doped with rare earths 130 other than erbium.

Moreover, the optical fiber 1 according to the present invention is not limited to the embodiment in which the concentration of rare earths 130 is high. The optical fiber according to the present invention may present a concentration of rare earths 130 of between about 250 ppm and 1,500 ppm while still attenuating or eliminating the PIQ and HUC mechanisms.

The present optical fibers may be manufactured by drawing from final preforms.

A final preform may be manufactured by providing a primary preform with an outer overcladding layer (i.e., an overcladding process). The outer overcladding layer typically consists of doped or undoped, natural or synthetic, silica glass. Several methods are available for providing the outer overcladding layer.

In a first exemplary method, the outer overcladding layer may be provided by depositing and vitrifying natural or synthetic silica particles on the outer periphery of the primary preform under the influence of heat. Such a process is known, for example, from U.S. Pat. Nos. 5,522,007, 5,194,714, 6,269,663, and 6,202,447, each of which is hereby incorporated by reference in its entirety.

In another exemplary method, a primary preform may be overcladded using a silica sleeve tube, which may or may not be doped. This sleeve tube may then be collapsed onto the primary preform.

In yet another exemplary method, an overcladding layer may be applied via an Outside Vapor Deposition (OVD) method. Here, a soot layer is first deposited on the outer periphery of a primary preform, and then the soot layer is vitrified to form glass.

The primary preforms may be manufactured via outside vapor deposition techniques, such as Outside Vapor Deposition (OVD) and Vapor Axial Deposition (VAD). Alternatively, the primary preforms may be manufactured via inside deposition techniques in which glass layers are deposited on the inner surface of a substrate tube of doped or undoped silica glass, such as Modified Chemical Vapor Deposition (MCVD), Furnace Chemical Vapor Deposition (FCVD), and Plasma Chemical Vapor Deposition (PCVD).

By way of example, the primary preforms may be manufactured using a PCVD process, which can precisely control the central core's gradient refractive index profile.

A depressed trench, for instance, may be deposited on the inner surface of a substrate tube as part of the chemical vapor deposition process. More typically, a depressed trench may be manufactured either (i) by using a fluorine-doped substrate tube as the starting point of the internal deposition process for deposition of the gradient refractive index central core or (ii) by sleeving a fluorine-doped silica tube over the gradient refractive index central core, which itself may be produced using an outside deposition process (e.g., OVD or VAD). Accordingly, a component glass fiber manufactured from the resulting preform may have a depressed trench located at the periphery of its central core.

As noted, a primary preform may be manufactured via an inside deposition process using a fluorine-doped substrate tube. The resulting tube containing the deposited layers may be sleeved by one or more additional fluorine-doped silica tubes so as to increase the thickness of a depressed trench, or to create a depressed trench having a varying refractive index over its width. Although not required, one or more additional sleeve tubes (e.g., fluorine-doped substrate tubes) may be collapsed onto the primary preform before an overcladding step is carried out. The process of sleeving and collapsing is sometimes referred to as jacketing and may be repeated to build several glass layers on the outside of the primary preform.

To supplement the present disclosure, this application incorporates entirely by reference the following commonly assigned patents, patent application publications, and patent applications: U.S. Pat. No. 4,838,643 for a Single Mode Bend Insensitive Fiber for Use in Fiber Optic Guidance Applications (Hodges et al.); U.S. Pat. No. 7,623,747 for a Single Mode Optical Fiber (de Montmorillon et al.); U.S. Pat. No. 7,587,111 for a Single-Mode Optical Fiber (de Montmorillon et al.); U.S. Pat. No. 7,356,234 for a Chromatic Dispersion Compensating Fiber (de Montmorillon et al.); U.S. Pat. No. 7,483,613 for a Chromatic Dispersion Compensating Fiber (Bigot-Astruc et al.); U.S. Pat. No. 7,526,177 for a Fluorine-Doped Optical Fiber (Matthijsse et al.); U.S. Pat. No. 7,555,186 for an Optical Fiber (Flammer et al.); U.S. Patent Application Publication No. US2009/0252469 A1 for a Dispersion-Shifted Optical Fiber (Sillard et al.); U.S. Pat. No. 8,041,172 for a Transmission Optical Fiber Having Large Effective Area (Sillard et al.); International Patent Application Publication No. WO 2009/062131 A1 for a Microbend-Resistant Optical Fiber, (Overton); U.S. Patent Application Publication No. US2009/0175583 A1 for a Microbend-Resistant Optical Fiber, (Overton); U.S. Patent Application Publication No. US2009/0279835 A1 for a Single-Mode Optical Fiber Having Reduced Bending Losses, filed May 6, 2009, (de Montmorillon et al.); U.S. Pat. No. 7,889,960 for a Bend-Insensitive Single-Mode Optical Fiber, (de Montmorillon et al.); U.S. Patent Application Publication No. US2010/0021170 A1 for a Wavelength Multiplexed Optical System with Multimode Optical Fibers, filed Jun. 23, 2009, (Lumineau et al.); U.S. Pat. No. 7,995,888 for a Multimode Optical Fibers, filed Jul. 7, 2009, (Gholami et al.); U.S. Patent Application Publication No. US2010/0119202 A1 for a Reduced-Diameter Optical Fiber, filed Nov. 6, 2009, (Overton); U.S. Patent Application Publication No. US2010/0142969 A1 for a Multimode Optical System, filed Nov. 6, 2009, (Gholami et al.); U.S. Patent Application Publication No. US2010/0118388 A1 for an Amplifying Optical Fiber and Method of Manufacturing, filed Nov. 12, 2009, (Pastouret et al.); U.S. Patent Application Publication No. US2010/0135627 A1 for an Amplifying Optical Fiber and Production Method, filed Dec. 2, 2009, (Pastouret et al.); U.S. Patent Application Publication No. US2010/0142033 for an Ionizing Radiation-Resistant Optical Fiber Amplifier, filed Dec. 8, 2009, (Regnier et al.); U.S. Patent Application Publication No. US2010/0150505 A1 for a Buffered Optical Fiber, filed Dec. 11, 2009, (Testu et al.); U.S. Patent Application Publication No. US2010/0171945 for a Method of Classifying a Graded-Index Multimode Optical Fiber, filed Jan. 7, 2010, (Gholami et al.); U.S. Patent Application Publication No. US2010/0189397 A1 for a Single-Mode Optical Fiber, filed Jan. 22, 2010, (Richard et al.); U.S. Patent Application Publication No. US2010/0189399 A1 for a Single-Mode Optical Fiber Having an Enlarged Effective Area, filed Jan. 27, 2010, (Sillard et al.); U.S. Patent Application Publication No. US2010/0189400 A1 for a Single-Mode Optical Fiber, filed Jan. 27, 2010, (Sillard et al.); U.S. Patent Application Publication No. US2010/0214649 A1 for an Optical Fiber Amplifier Having Nanostructures, filed Feb. 19, 2010, (Burow et al.); U.S. Pat. No. 8,009,950 for a Multimode Fiber, filed Apr. 22, 2010, (Molin et al.); U.S. Patent Application Publication No. US2010/0310218 A1 for a Large Bandwidth Multimode Optical Fiber Having a Reduced Cladding Effect, filed Jun. 4, 2010, (Molin et al.); U.S. Patent Application Publication No. US2011/0058781 A1 for a Multimode Optical Fiber Having Improved Bending Losses, filed Sep. 9, 2010, (Molin et al.); U.S. Patent Application Publication No. US2011/0064367 A1 for a Multimode Optical Fiber, filed Sep. 17, 2010, (Molin et al.); U.S. Patent Application Publication No. US2011/0069724 A1 for an Optical Fiber for Sum-Frequency Generation, filed Sep. 22, 2010, (Richard et al.); U.S. Patent Publication No. US2011/0116160 A1 for a Rare-Earth-Doped Optical Fiber Having Small Numerical Aperture, filed Nov. 11, 2010, (Boivin et al.); U.S. Patent Publication No. US2011/0123161 A1 for a High-Bandwidth, Multimode Optical Fiber with Reduced Cladding Effect, filed Nov. 24, 2010, (Molin et al.); U.S. Patent Publication No. US2011/0123162 A1 for a High-Bandwidth, Dual-Trench-Assisted Multimode Optical Fiber, filed Nov. 24, 2010, (Molin et al.); U.S. Patent Publication No. US2011/0135262 A1 for a Multimode Optical Fiber with Low Bending Losses and Reduced Cladding Effect, filed Dec. 3, 2010, (Molin et al.); U.S. Patent Publication No. US2011/0135263 A1 for a High-Bandwidth Multimode Optical Fiber Having Reduced Bending Losses, filed Dec. 3, 2010, (Molin et al.); U.S. Patent Publication No. US2011/0188826 A1 for a Non-Zero Dispersion Shifted Optical Fiber Having a Large Effective Area, filed Jan. 31, 2011, (Sillard et al.); U.S. Patent Publication No. US2011/0188823 A1 for a Non-Zero Dispersion Shifted Optical Fiber Having a Short Cutoff Wavelength, filed Jan. 31, 2011, (Sillard et al.); U.S. Patent Publication No. 2011/0217012 A1 for a Broad-Bandwidth Multimode Optical Fiber Having Reduced Bending Losses, filed Mar. 1, 2011, (Bigot-Astruc et al.); U.S. Patent Publication No. 2011/0229101 A1 for a Single-Mode Optical Fiber, filed Mar. 15, 2011, (de Montmorillon et al.); U.S. patent application Ser. No. 13/175,181 for a Single-Mode Optical Fiber, filed Jul. 1, 2011, (Bigot-Astruc et al.); U.S. patent application Ser. No. 13/206,943 for a Method of Fabricating an Optical Fiber Preform, filed Aug. 10, 2011, (de Montmorillon et al.); U.S. patent application Ser. No. 13/275,921 for a Multimode Optical Fiber Insensitive to Bending Losses, filed Oct. 18, 2011, (Molin et al.); and U.S. patent application Ser. No. 13/303,967 for a Radiation-Insensitive Optical Fiber Doped with Rare Earths, filed Nov. 23, 2011, (Burow et al.).

To supplement the present disclosure, this application further incorporates entirely by reference the following commonly assigned patents, patent application publications, and patent applications: U.S. Pat. No. 5,574,816 for Polypropylene-Polyethylene Copolymer Buffer Tubes for Optical Fiber Cables and Method for Making the Same; U.S. Pat. No. 5,717,805 for Stress Concentrations in an Optical Fiber Ribbon to Facilitate Separation of Ribbon Matrix Material; U.S. Pat. No. 5,761,362 for Polypropylene-Polyethylene Copolymer Buffer Tubes for Optical Fiber Cables and Method for Making the Same; U.S. Pat. No. 5,911,023 for Polyolefin Materials Suitable for Optical Fiber Cable Components; U.S. Pat. No. 5,982,968 for Stress Concentrations in an Optical Fiber Ribbon to Facilitate Separation of Ribbon Matrix Material; U.S. Pat. No. 6,035,087 for an Optical Unit for Fiber Optic Cables; U.S. Pat. No. 6,066,397 for Polypropylene Filler Rods for Optical Fiber Communications Cables; U.S. Pat. No. 6,175,677 for an Optical Fiber Multi-Ribbon and Method for Making the Same; U.S. Pat. No. 6,085,009 for Water Blocking Gels Compatible with Polyolefin Optical Fiber Cable Buffer Tubes and Cables Made Therewith; U.S. Pat. No. 6,215,931 for Flexible Thermoplastic Polyolefin Elastomers for Buffering Transmission Elements in a Telecommunications Cable; U.S. Pat. No. 6,134,363 for a Method for Accessing Optical Fibers in the Midspan Region of an Optical Fiber Cable; U.S. Pat. No. 6,381,390 for a Color-Coded Optical Fiber Ribbon and Die for Making the Same; U.S. Pat. No. 6,181,857 for a Method for Accessing Optical Fibers Contained in a Sheath; U.S. Pat. No. 6,314,224 for a Thick-Walled Cable Jacket with Non-Circular Cavity Cross Section; U.S. Pat. No. 6,334,016 for an Optical Fiber Ribbon Matrix Material Having Optimal Handling Characteristics; U.S. Pat. No. 6,321,012 for an Optical Fiber Having Water Swellable Material for Identifying Grouping of Fiber Groups; U.S. Pat. No. 6,321,014 for a Method for Manufacturing Optical Fiber Ribbon; U.S. Pat. No. 6,210,802 for Polypropylene Filler Rods for Optical Fiber Communications Cables; U.S. Pat. No. 6,493,491 for an Optical prop Cable for Aerial Installation; U.S. Pat. No. 7,346,244 for a Coated Central Strength Member for Fiber Optic Cables with Reduced Shrinkage; U.S. Pat. No. 6,658,184 for a Protective Skin for Optical Fibers; U.S. Pat. No. 6,603,908 for a Buffer Tube that Results in Easy Access to and Low Attenuation of Fibers Disposed Within Buffer Tube; U.S. Pat. No. 7,045,010 for an Applicator for High-Speed Gel Buffering of Flextube Optical Fiber Bundles; U.S. Pat. No. 6,749,446 for an Optical Fiber Cable with Cushion Members Protecting Optical Fiber Ribbon Stack; U.S. Pat. No. 6,922,515 for a Method and Apparatus to Reduce Variation of Excess Fiber Length in Buffer Tubes of Fiber Optic Cables; U.S. Pat. No. 6,618,538 for a Method and Apparatus to Reduce Variation of Excess Fiber Length in Buffer Tubes of Fiber Optic Cables; U.S. Pat. No. 7,322,122 for a Method and Apparatus for Curing a Fiber Having at Least Two Fiber Coating Curing Stages; U.S. Pat. No. 6,912,347 for an Optimized Fiber Optic Cable Suitable for Microduct Blown Installation; U.S. Pat. No. 6,941,049 for a Fiber Optic Cable Having No Rigid Strength Members and a Reduced Coefficient of Thermal Expansion; U.S. Pat. No. 7,162,128 for Use of Buffer Tube Coupling Coil to Prevent Fiber Retraction; U.S. Pat. No. 7,515,795 for a Water-Swellable Tape, Adhesive-Backed for Coupling When Used Inside a Buffer Tube (Overton et al.); U.S. Patent Application Publication No. 2008/0292262 for a Grease-Free Buffer Optical Fiber Buffer Tube Construction Utilizing a Water-Swellable, Texturized Yarn (Overton et al.); European Patent Application Publication No. 1,921,478 A1, for a Telecommunication Optical Fiber Cable (Tatat et al.); U.S. Pat. No. 7,702,204 for a Method for Manufacturing an Optical Fiber Preform (Gonnet et al.); U.S. Pat. No. 7,570,852 for an Optical Fiber Cable Suited for Blown Installation or Pushing Installation in Microducts of Small Diameter (Nothofer et al.); U.S. Pat. No. 7,646,954 for an Optical Fiber Telecommunications Cable (Tatat); U.S. Pat. No. 7,599,589 for a Gel-Free Buffer Tube with Adhesively Coupled Optical Element (Overton et al.); U.S. Pat. No. 7,567,739 for a Fiber Optic Cable Having a Water-Swellable Element (Overton); U.S. Pat. No. 7,817,891 for a Method for Accessing Optical Fibers within a Telecommunication Cable (Lavenne et al.); U.S. Pat. No. 7,639,915 for an Optical Fiber Cable Having a Deformable Coupling Element (Parris et al.); U.S. Pat. No. 7,646,952 for an Optical Fiber Cable Having Raised Coupling Supports (Parris); U.S. Pat. No. 7,724,998 for a Coupling Composition for Optical Fiber Cables (Parris et al.); U.S. Patent Application Publication No. US2009/0214167 A1 for a Buffer Tube with Hollow Channels, (Lookadoo et al.); U.S. Patent Application Publication No. US2009/0297107 A1 for an Optical Fiber Telecommunication Cable, filed May 15, 2009, (Tatat); U.S. Patent Application Publication No. US2009/0279833 A1 for a Buffer Tube with Adhesively Coupled Optical Fibers and/or Water-Swellable Element, filed Jul. 21, 2009, (Overton et al.); U.S. Patent Application Publication No. US2010/0092135 A1 for an Optical Fiber Cable Assembly, filed Sep. 10, 2009, (Barker et al.); U.S. Pat. No. 7,974,507 A1 for a High-Fiber-Density Optical Fiber Cable (Louie et al.); U.S. Pat. No. 7,970,247 for a Buffer Tubes for Mid-Span Storage (Barker); U.S. Patent Application Publication No. US2010/0135623 A1 for Single-Fiber prop Cables for MDU Deployments, filed Nov. 9, 2009, (Overton); U.S. Pat. No. 8,041,167 for an Optical-Fiber Loose Tube Cables, filed Nov. 9, 2009, (Overton); U.S. Patent Application Publication No. US2010/0135624 A1 for a Reduced-Size Flat prop Cable, filed Nov. 9, 2009, (Overton et al.); U.S. Patent Application Publication No. US2010/0092138 A1 for ADSS Cables with High-Performance Optical Fiber, filed Nov. 9, 2009, (Overton); U.S. Pat. No. 8,041,168 for Reduced-Diameter Ribbon Cables with High-Performance Optical Fiber, filed Nov. 10, 2009, (Overton); U.S. Pat. No. 8,031,997 for a Reduced-Diameter, Easy-Access Loose Tube Cable, filed Nov. 10, 2009, (Overton); U.S. Patent Application Publication No. US2010/0154479 A1 for a Method and Device for Manufacturing an Optical Preform, filed Dec. 19, 2009, (Milicevic et al.); U.S. Patent Application Publication No. US 2010/0166375 for a Perforated Water-Blocking Element, filed Dec. 29, 2009, (Parris); U.S. Patent Application Publication No. US2010/0183821 A1 for a UVLED Apparatus for Curing Glass-Fiber Coatings, filed Dec. 30, 2009, (Hartsuiker et al.); U.S. Patent Application Publication No. US2010/0202741 A1 for a Central-Tube Cable with High-Conductivity Conductors Encapsulated with High-Dielectric-Strength Insulation, filed Feb. 4, 2010, (Ryan et al.); U.S. Patent Application Publication No. US2010/0215328 A1 for a Cable Having Lubricated, Extractable Elements, filed Feb. 23, 2010, (Tatat et al.); U.S. Patent Application Publication No. US2011/0026889 A1 for a Tight-Buffered Optical Fiber Unit Having Improved Accessibility, filed Jul. 26, 2010, (Risch et al.); U.S. Patent Application Publication No. US2011/0064371 A1 for Methods and Devices for Cable Insertion into Latched Conduit, filed Sep. 14, 2010, (Leatherman et al.); U.S. Patent Publication No. 2011/0069932 A1 for a High-Fiber-Density Optical-Fiber Cable, filed Oct. 19, 2010, (Overton et al.); U.S. Patent Publication No. 2011/0091171 A1 for an Optical-Fiber Cable Having High Fiber Count and High Fiber Density, filed Oct. 19, 2010, (Tatat et al.); U.S. Patent Publication No. 2011/0176782 A1 for a Water-Soluble Water-Blocking Element, filed Jan. 19, 2011, (Parris); U.S. Patent Publication No. 2011/0268400 A1 for a Data-Center Cable, filed Apr. 28, 2011, (Lovie et al.); U.S. Patent Publication No. 2011/0268398 A1 for a Bundled Fiber Optic Cables, filed May 3, 2011, (Quinn et al.); U.S. Patent Publication No. 2011/0287195 A1 for a Curing Apparatus Employing Angled UVLEDs, filed May 19, 2011, (Molin); U.S. patent application Ser. No. 13/116,141 for a Low-Smoke and Flame-Retardant Fiber Optic Cables, filed May 26, 2011, (Lovie et al.); U.S. patent application Ser. No. 13/152,651 for a Curing Apparatus Having UV Sources That Emit Differing Ranges of UV Radiation, filed Jun. 3, 2011, (Gharbi et al.); U.S. patent application Ser. No. 13/181,762 for a Adhesively Coupled Optical Fibers and Enclosing Tape, filed Jul. 13, 2011, (Parris); U.S. patent application Ser. No. 13/206,601 for a Method and Apparatus Providing Increased UVLED Intensity, filed Aug. 10, 2011, (Overton); U.S. patent application Ser. No. 13/222,329 for an Optical-Fiber Module Having Improved Accessibility, filed Aug. 31, 2011, (Tatat); and U.S. patent application Ser. No. 13/310,299 for a Buffer Tubes Having Reduced Stress Whitening, filed Dec. 2, 2010, (Risch).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. An optical fiber, comprising:
a central core comprising a core matrix and nanoparticles, said core matrix surrounding said nanoparticles; and
an optical cladding surrounding said central core;
wherein said nanoparticles comprise (i) rare-earth-dopant elements, (ii) a nanoparticle matrix, and (iii) an outer layer, said nanoparticle matrix surrounding said rare-earth-dopant elements and said outer layer surrounding said nanoparticle matrix;
wherein, within said nanoparticles, the atomic ratio of nanoparticle matrix atoms other than oxygen to rare-earth-dopant element atoms is between about 300 and 1,000; and
wherein said outer layer is formed of an outer layer matrix that is substantially free from rare-earth-dopant element atoms and said outer layer has a thickness of between about 1 nanometer and 2 nanometers.

2. The optical fiber according to claim 1, wherein said core matrix is made of silica.

3. The optical fiber according to claim 1, wherein said nanoparticle matrix comprises alumina and/or silica (SiO₂).

4. The optical fiber according to claim 1, wherein said outer layer matrix is made of alumina (Al₂O₃) and/or silica (SiO₂).

5. The optical fiber according to claim 1, wherein said rare-earth-dopant elements are erbium (Er), ytterbium (Yb), and/or thulium (Tm).

6. The optical fiber according to claim 1, wherein, within said nanoparticles, the atomic ratio of nanoparticle matrix atoms other than oxygen to rare-earth-dopant element atoms is between about 350 and 550.

7. The optical fiber according to claim 1, wherein, for at least 80 percent of said nanoparticles, the atomic ratio of nanoparticle matrix atoms other than oxygen to rare-earth-dopant element atoms is between about 300 and 1,000.

8. The optical fiber according to claim 1, wherein, within said central core, the concentration of said nanoparticle matrix is between about 0.5 weight percent and 3.5 weight percent.

9. The optical fiber according to claim 1, wherein said nanoparticles are substantially spherical and have diameters of between about 5 nanometers and 50 nanometers.

10. The optical fiber according to claim 1, wherein, within said central core, the concentration of said rare-earth-dopant elements is between about 250 ppm and 1,500 ppm.

11. The optical fiber according to claim 1, wherein, for at least 80 percent of said nanoparticles, said outer layer is formed of an outer layer matrix that is substantially free from rare-earth-dopant element atoms and said outer layer has a thickness of between about 1 nanometer and 2 nanometers.

12. The optical fiber according to claim 1, wherein said core matrix comprises an additional dopant that contributes to a refractive index difference between said central core and said optical cladding.

13. The optical fiber according to claim 12, wherein said additional dopant is germanium, fluorine, aluminum, and/or phosphorous.

14. An optical fiber laser comprising the optical fiber according to claim 1.

15. An optical amplifier comprising the optical fiber according to claim 1, wherein the optical amplifier provides amplification at a pump power of between about 60 mW and 1,500 mW.

16. An optical fiber, comprising:
a central core surrounded by an optical cladding, said central core comprising nanoparticles dispersed within a core matrix;
wherein said nanoparticles comprise an outer layer surrounding rare-earth dopants dispersed within a nanoparticle matrix, said outer layer being substantially free from rare-earth dopants;
wherein the concentration of said rare-earth dopants within said central core is at least about 250 ppm;
wherein, for at least 80 percent of said nanoparticles, the average distance d₁ separating adjacent rare-earth dopants within the same nanoparticle is at least about 2 nanometers; and
wherein, for at least 80 percent of said nanoparticles, the distance d₂ separating rare-earth dopants within different nanoparticles is at least about 2 nanometers.

17. The optical fiber according to claim 16, wherein, for at least 90 percent of said nanoparticles, (i) the average distance d₁ separating adjacent rare-earth dopants within the same nanoparticle is at least about 2 nanometers, and (ii) the distance d₂ separating rare-earth dopants within different nanoparticles is at least about 2 nanometers.

18. The optical fiber according to claim 16, wherein, for at least 95 percent of said nanoparticles, (i) the average distance d₁ separating adjacent rare-earth dopants within the same nanoparticle is at least about 2 nanometers, and (ii) the distance d₂ separating rare-earth dopants within different nanoparticles is at least about 2 nanometers.

19. The optical fiber according to claim 16, wherein:
said nanoparticle matrix comprises alumina and/or silica; and
the concentration of said nanoparticle matrix within said central core is between about 0.5 weight percent and 3.5 weight percent.

20. The optical fiber according to claim 16, wherein:
said rare-earth dopants are erbium (Er), ytterbium (Yb), and/or thulium (Tm); and
the concentration of said rare-earth dopants within said central core is between about 250 ppm and 1,500 ppm.
